(19) United States
(12) Patent Application Publication
(10) Pub. No.: US 2009/0212904 A1
(43) Pub. Date: Aug. 27, 2009

(54) Electronic device provided with theft prevention function, and method for preventing theft of electronic devices

(75) Inventors: Akihiko Yamashita, Ashiya-shi (JP); Akinori Tsubouchi, Takarazuka City (JP)

Correspondence Address: MASUVALLEY & PARTNERS, 8765 AERO DRIVE, SUITE 312, SAN DIEGO, CA, 92123, US

(73) Assignees: Sanyo Electric Co., Ltd., Moriguchi City (JP); Sanyo Visual Technology Inc., Daito City (JP)

(21) Appl. No.: 12/072,158

(22) Filed: Feb. 25, 2008

(51) Int. Cl. H04L 9/32

(52) U.S. Cl. 340/5.22

(57) ABSTRACT

An electronic device includes: a memory storing a first lock release code; a comparing portion comparing the first lock release code with a second lock release code that is input with an input device; a controlling portion releasing a lock if the comparing portion finds that the first lock release code matches the second lock release code, and permitting the electronic device to operate normally; and a lock release portion releasing the lock, even if the comparing portion finds that the first lock release code does not match the second lock release code, or no code input is made, when a first predetermined time elapses from a predetermined time point.

### BACKGROUND OF THE INVENTION

1. Field of the Invention

The present invention relates to an electronic device provided with theft prevention function, and to a method for preventing theft of electronic devices.

2. Description of Related Art

Conventionally, a typical method for preventing theft of electronic devices is to, for example, embed a sensor called a sensor tag in a piece of merchandise or to attach the sensor tag to a carton case of the merchandise, and install a sensor in the doorway of a store to detect and sound a buzzer when the merchandise is removed from the store without deactivating the function of the sensor at a cash register. However, questions are raised about the effectiveness of this method because the sensor tag loses its effect once it is detached, and the electronic devices are nevertheless stolen even if the buzzer goes off.

And, JP-A-2007-81669 discloses a method for preventing theft of a television receiver. This invention is directed to a method of storing the contact information of a user in a television receiver, and informing the user of theft via a network if the television receiver is judged to have been stolen.

Also, JP-A-2001-347894 discloses a theft prevention method for use in a motor vehicle. In this invention, in-vehicle electrical components are disabled once a vehicle is put on the alert in case of theft. Thereafter, the in-vehicle electrical components remain disabled unless they are brought out of the disabled state in some way. The method for bringing the in-vehicle electrical components out of the disabled state is to match a unique signal stored in the antitheft device on the vehicle with an unique signal stored in a memory provided separately.

Further, U.S. Pat. No. 4,987,594 discloses an invention which makes a radio receiver or a television receiver unusable by blocking a reception signal or generating a sound if no permission for the use is given, and thereby prevents theft of these receivers.

However, none of these inventions described above is adequate to prevent theft of electronic devices from stores.

It is for this reason that, as an electronic device having a function of preventing theft of electronic devices from stores, an electronic device has been proposed that is permitted to operate normally only when a first lock release code that is previously stored in a memory thereof matches a second lock release code that is input with an input device (U.S. patent application Ser. No. 11/895849). An authorized purchaser can use the electronic device without any problem because they can get a correct second lock release code in the store, for example. By contrast, a person who is not an authorized purchaser cannot operate the electronic device normally because they cannot input a correct second lock release code. In this way, this electronic device produces an effect of preventing theft of electronic devices from stores.

To enhance the effect of preventing theft of electronic devices, it is preferable that different first lock release codes be set one for each of the electronic devices.

However, in a case where different first lock release codes are set one for each of the electronic devices, the following problem arises. The store clerks may fail to input the correct second lock release code when they put the electronic device on display in the store, and therefore are unable to operate the electronic device normally, even if they put it on display. To avoid such a problem, a previously determined master code may be prepared, such that all the electronic devices can be successfully unlocked by inputting the same master code. In this case, however, if the master code is leaked to a malicious user, the theft prevention function of the electronic devices loses its effectiveness.

### SUMMARY OF THE INVENTION

According to one aspect of the present invention, an electronic device is provided with: a memory storing a first lock release code; a comparing portion comparing the first lock release code with a second lock release code that is input with an input device; a controlling portion releasing a lock if the comparing portion finds that the first lock release code matches the second lock release code, and permitting the electronic device to operate normally; and a lock release portion releasing the lock, even if the comparing portion finds that the first lock release code does not match the second lock release code, or no code input is made, when a first predetermined time elapses from a predetermined time point.

According to another aspect of the present invention, a method for preventing theft of an electronic device is provided with the steps of: storing a lock release code in a memory of the electronic device; generating information corresponding to the lock release code stored in the memory; making the electronic device request an input of the information corresponding to the lock release code; comparing the input information with the lock release code stored in the memory; releasing a lock if the input information is found to match the lock release code in the comparing step, and permitting the electronic device to operate normally; and releasing the lock, even if the input information is found not to match the lock release code in the comparing step, or no input of the information is made, when a first predetermined time elapses from a predetermined time point.

Preferably, the predetermined time point is determined, for example, based on a time point at which power of the electronic device is turned on.

Preferably, the predetermined time point is, for example, a start point of a duration of time that no operation is performed with the input device or an input device for inputting the information corresponding to the lock release code.

Preferably, when the first predetermined time elapses from the predetermined time point, the lock is temporarily released. In this case, for example, the lock may be temporarily released when the first predetermined time elapses from the predetermined time point, and a temporary release of the lock may be maintained until a time when the power of the electronic device is turned off. Alternatively, for example, the lock may be temporarily released when the first predetermined time elapses from the predetermined time point, and a temporary release of the lock may be maintained until a time when a second predetermined time elapses from a start of the temporary release of the lock. Alternatively, for example, the lock may be temporarily released when the first predetermined time elapses from the predetermined time point, and a temporary release of the lock may be maintained until a time when the power of the electronic device is turned off before a second predetermined time elapses from a start of the temporary release of the lock, or until a time when the second predetermined time elapses from a start of the temporary release of the lock before the power of the electronic device is turned off.

Preferably, the first predetermined time is sufficiently longer than a time required by a user to release the lock by using the input device or an input device for inputting the information corresponding to the lock release code.

An example of the electronic device is a television receiver.

Preferably, the input device or an input device for inputting the information corresponding to the lock release code is a remote control transmitter provided separately from the electronic device, and the electronic device is provided with a receiving portion for receiving a signal transmitted from the remote control transmitter.

### BRIEF DESCRIPTION OF THE DRAWINGS

FIG. 1 is a block diagram of a television receiver according to the present invention.

FIG. 2 shows a portion of a production process of the television receiver shown in FIG. 1.

FIG. 3 shows a procedure for issuing information corresponding to a lock release code.

FIG. 4 shows an example of a flowchart of operation of the television receiver shown in FIG. 1.

FIG. 5 is an example of a screen in which a television receiver requests an input of information corresponding to a lock release code.

FIG. 6 shows an example of a screen when a user inputs information which does not match a lock release code.

FIGS. 7A to 7C each show another example of the flowchart of operation of the television receiver shown in FIG. 1.

### DETAILED DESCRIPTION OF PREFERRED EMBODIMENTS

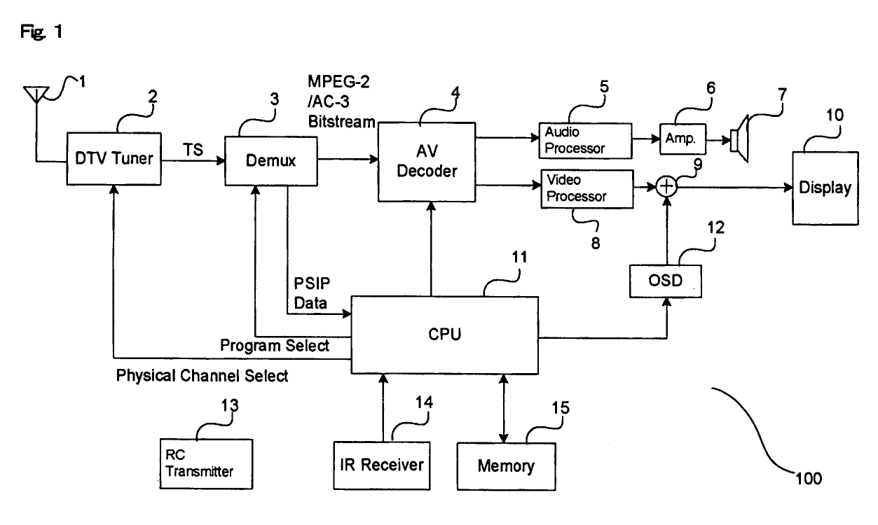

FIG. 1 shows a block diagram of a television receiver 100 according to the present invention. In this embodiment, an U.S. digital television receiver which receives an ATSC (Advanced Television Systems Committee) signal is described as an embodiment.

A terrestrial antenna 1 receives a digital terrestrial broadcasting wave, and supplies a received signal to a digital terrestrial tuner 2. The digital terrestrial tuner 2 selects a physical channel by a channel select signal from a CPU or a microprocessor 11. The digital terrestrial tuner 2 converts a high frequency 8VSB (8-level vestigial sideband) digital modulation signal including video/audio data to a specific frequency signal by this channel select process. Also, the digital terrestrial tuner 2 is provided with an 8VSB demodulation circuit or the like to demodulate the digital modulation signal of selected physical channel, and outputs a transport stream TS.

A demultiplexer (DEMUX) 3 divides the transport stream TS received from the digital terrestrial tuner 2 into a predetermined packet, namely a video stream of MPEG-2, an audio stream of AC-3 (AC-3 is a registered trade mark of Dolby Laboratories Licensing Corporation), and PSIP (Program and System Information Protocol) data, and receives a program select signal from the CPU 11. The demultiplexer 3 supplies the video stream and the audio stream to an AV decoder 4, and PSIP data, which includes program information, is supplied to the CPU 11.

The CPU 11 performs various controls of the television receiver 100, as well as processing of the PSIP data, and processing of remote control signals described later. In addition, the CPU 11 has two separate timer functions. A memory 15 is connected to the CPU 11, and the memory 15 stores various data including the program information and a lock release code described later.

A plurality of channels are multiplexed in the transport steam TS, and the process of selecting an arbitrary channel from these channels can be made by retrieving the channel information, which describes packet IDs for video and audio streams in the PSIP.

An AV decoder 4 is provided with an MPEG video decoder (not shown) for decoding the MPEG-2 bit stream, and an AC-3 decoder (not shown) for decoding the audio stream (AC-3 bit stream). The video data generated by the decoder of AV decoder 4 is output to a video processor 8, and the audio data is output to an audio processor 5.

The video processor 8 receives the video data from the AV decoder 4 and generates a video signal by performing D/A conversion. The audio processor 5 receives the audio data output from the AV decoder 4 and generates an analog audio signal by performing D/A conversion.

An OSD (On Screen Display) circuit 12 outputs a video signal to an adder 9 based on the character information instructed to output from the CPU 11. The adder 9 adds the video signal based on the bitmap data and the reception video signal, and supplies the resultant video signal to a display 10, such as an LCD.

The display 10 displays images according to the video signal supplied from the video processor 8. Also, the analog audio signal from the audio process circuit 5 is output from a speaker 7 after being amplified with an amplifier 6.

A remote control transmitter 13 is a transmitter to transmit various instructions to the television receiver 100. When a key (not shown) provided on this remote control transmitter 13 is operated, an IR (Infrared) signal (remote control signal), which is an instruction corresponding to the key, is transmitted from a light emitting portion (not shown). An IR receiver 14 receives the signal light, converts it into an electrical signal, and supplies it to the CPU 11.

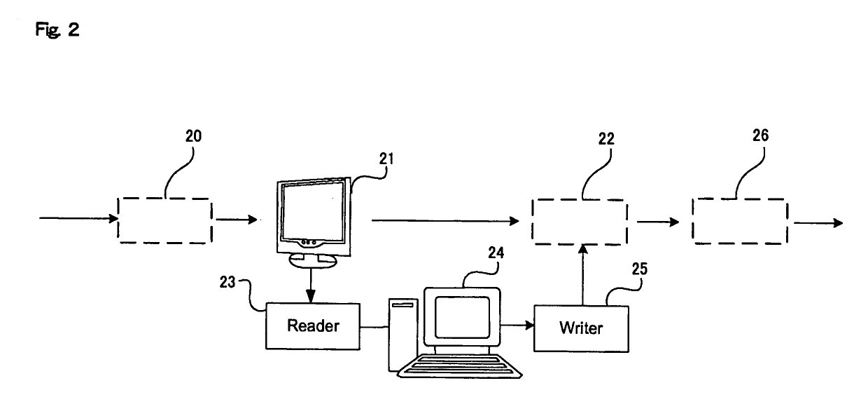

FIG. 2 shows a portion of a production process of the television receiver shown in FIG. 1. Each television receiver manufactured in a factory may be provided with a serial number. The serial number may be provided by attaching a barcode indicating the serial number onto the main body of the television receiver. The code other than a barcode, such as a two-dimensional code, may be used instead.

As shown in FIG. 2, the television receiver which was subjected to a predetermined process in a manufacturing process 20 is transferred to the next manufacturing process 21. In the manufacturing process 21, the barcode indicating the serial number provided to the television receiver is read by a barcode reader 23. And the serial number is input to a PC (personal computer) 24. The PC 24 has software which is capable of generating different lock release codes, one for each of the serial numbers. The PC 24 creates the lock release code with the software. The created lock release code is transferred to a writer 25.

In a manufacturing process 22, the lock release code is written in the memory 15 of the television receiver by the writer 25. This writer 25 may be a remote controller transmitting portion to transmit the signal of the lock release code received from the PC 24 as an infrared remote control signal. The lock release code transmitted from the writer 25 is received by the IR receiver 14 of the television receiver and stored in the memory 15 through the CPU 11 (shown in FIG. 1). The television receiver storing the lock release code is delivered as goods (process 26).

In this way, one lock release code corresponds to one serial number and is stored in the television receiver. In addition, the information corresponding to the lock release code is generated. The serial number, the information corresponding to the lock release code, and the lock release code correspond to one another. Also, the information corresponding to the lock release code and the lock release code are generated to match.

Reading of the serial number may be in any form. For example, an IIC bus may be used. That is, the serial number is written in the memory 15 of the television receiver in the manufacturing process 20, and the serial number is read into the PC 24 through the IIC bus in the manufacturing process 21.

A lock release code corresponding to the serial number is generated in the PC 24, and the lock release code thus generated may be written on the memory 15 of the television receiver by the IIC bus. Also, the information to create the lock release code is not limited to the serial number, it may be anything. It may be the date of manufacture of the television receiver. The method for generating the lock release code is not limited to that of FIG. 2, it may be any method.

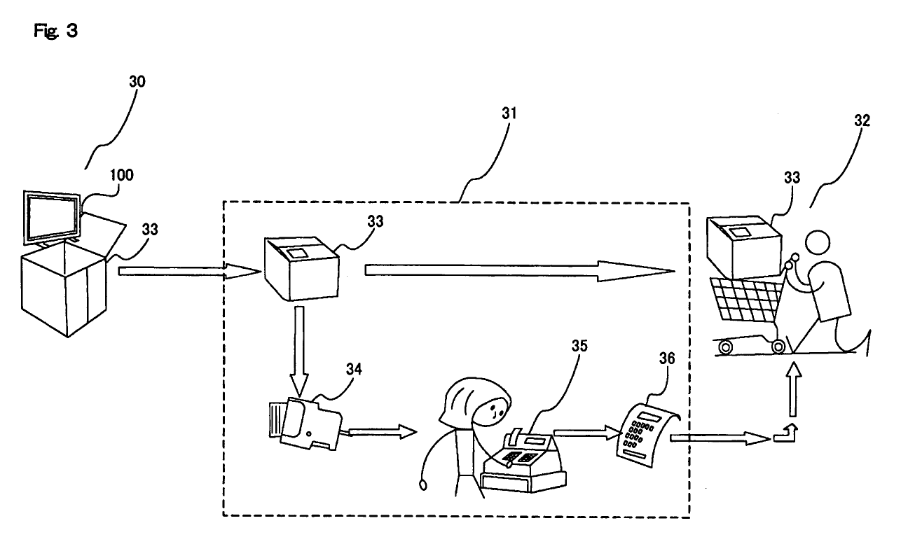

FIG. 3 shows a procedure for issuing the information corresponding to the lock release code. In a manufacturing process 30, the television receiver 100 is packaged. In a sales process 31, the barcode indicating the serial number attached to the packaged television receiver 33 is read by a barcode reader 34. The read serial number is imported to a register device 35. The register device 35 is capable of obtaining the information corresponding to the lock release code from an individual serial number. The obtained information corresponding to the lock release code is printed on a receipt 36 which indicates a record of purchase, and handed to a purchaser (process 32).

The information corresponding to the lock release code is not necessarily printed on a receipt, and it may be given to a purchaser in any form. For example, it may be printed on a separate form from the receipt. Also, reading the serial number is not limited to the barcode reader, it may be transmitted to a register in any form. For example, the serial number may be input to a register directly by a store clerk. Also, instead of transmitting the serial number to the register, the information corresponding to the lock release code may be obtained by transmitting the serial number to another device. Also, the number other than the serial number may be used and it may be in any form, or a time to obtain the information corresponding to the lock release code may be in any form.

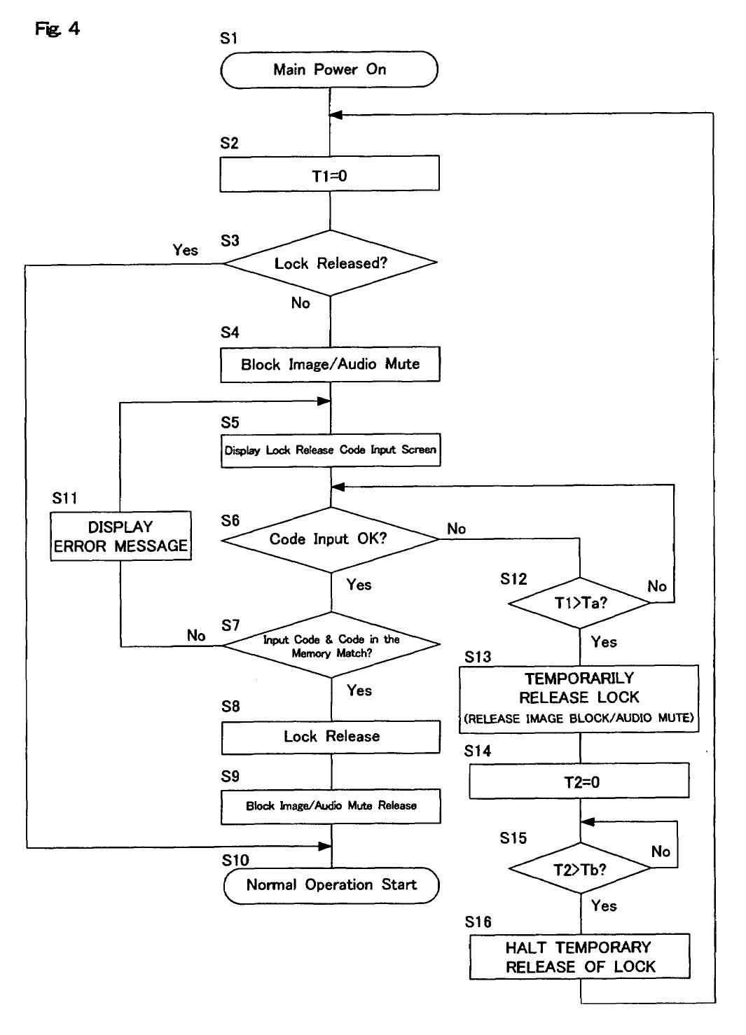

FIG. 4 shows an example of a flowchart of the operation of the television receiver shown in FIG. 1. First, when the power of the television receiver is turned on (step SI), the CPU 11 of the television receiver resets a measurement time T1, if any, measured with a first timer to zero, and starts to measure the time with the first timer (step S2). The CPU 11 of the television receiver checks if the lock for images and so on has been released or not (step S3). If the lock is found to have been released, the television receiver starts channel select preset operation, image display, and audio output (step S10). If the CPU 11 of the television receiver finds that the lock for the image display and so on has not been released, the image is blocked and the audio is muted (step S4).

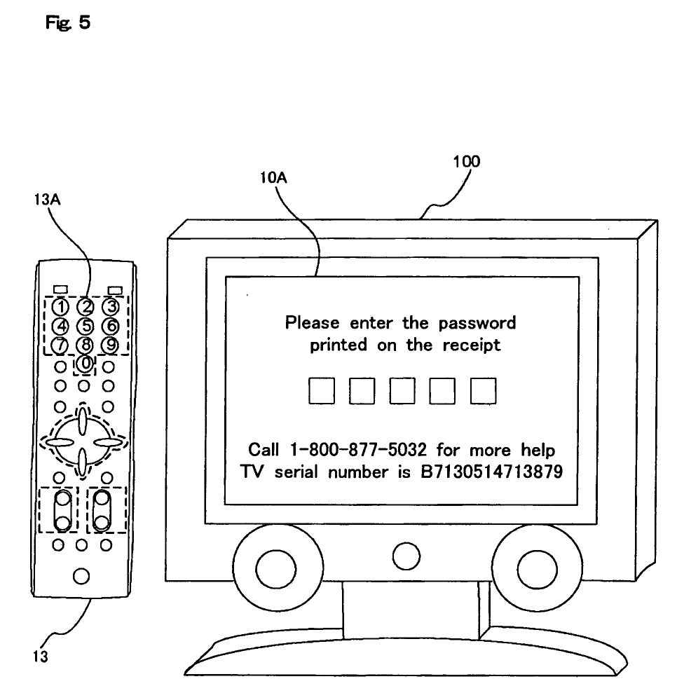

Thereafter, for example, a display requesting an input of the information corresponding to the lock release code is displayed on the screen of the television receiver as explained in FIG. 5 (step S5). The user inputs the information corresponding to the lock release code by using a remote controller or the like according to this instruction. Then, the television receiver determines whether there is an input from the user or not (step S6).

When there is an input in step S6, a determination is made at the comparing portion of the television receiver as to whether the information matches the lock release code or not (step S7). Incidentally, in this embodiment, the CPU 11 of the television receiver functions as the comparing portion of the television receiver. When it is determined that the information does not match the lock release code, an error message appears on the screen saying that the information does not match the lock release code (step S11). Then, the procedure goes back to step S5, and an input of the information corresponding to the lock release code is requested again. When it is determined that the information matches the lock release code, the lock for the image and the audio is released, that is, the data of a lock release flag (a flag indicating whether the lock has been released or not) stored in the memory 15 is changed from “Lock” to “Not Lock” (step S8). When the lock is released, the image block and the audio mute are released (step S9), the television receiver starts a channel select preset operation, image display, and audio output (step S10).

When there is no input in step S6, the CPU 11 of the television receiver checks whether or not the measurement time T1 measured with the first timer exceeds a previously determined time Ta (step S12). If the measurement time T1 measured with the first timer is found not to exceed the time Ta, the procedure goes back to step S6, and an input of the information corresponding to the lock release code is waited for. If the measurement time T1 measured with the first timer is found to exceed the time Ta, the lock for the image and the audio is temporarily released with the data of the lock release flag stored in the memory 15 being left in a “Lock” state, and thereby the image block and the audio mute are released (step S13). Then, the CPU 11 of the television receiver resets a measurement time T2, if any, measured with a second timer to zero, and starts to measure the time with the second timer (step S14). The CPU 11 of the television receiver then checks whether or not the measurement time T2 measured with the second timer exceeds a previously determined time Tb (step S15). If the measurement time T2 measured with the second timer is found not to exceed the time Tb, the procedure is stopped for a given time in step S15. If the measurement time T2 measured with the second timer is found to exceed the time Tb, a temporary release of the lock for the image and the audio is halted (step S16). Then, the procedure goes back to step S2, and processes are repeatedly performed except for turning the main power on.

Preferably, the time Ta is set to be sufficiently longer (for example, five minutes) than the time required by the user to release the lock, and the time Tb is set to a time (for example, eight hours) long enough to allow plenty of time to put the electronic device on display in the store.

Since the television receiver shown in FIG. 1 operates in the manner as described above, it is possible to bypass the need to input the correct lock release code when putting it on display in the store and making it operate normally.

FIG. 5 shows an example of a screen in which the television receiver is requesting an input of the information corresponding to a lock release code. FIG. 5 shows a television receiver 100 and a remote control transmitter 13, which is an example of the remote controller. The remote control transmitter 13 has a plurality of inputs 13A. The television receiver 100 has a display screen 10A. The display screen 10A is displaying “Please enter the password printed on the receipt” and “Call 1-800-877-5032 for more help TV serial number is B7130514713879”. In this case, the serial number is written into the memory 15 of the television receiver in advance.

A user inputs the information corresponding to the lock release code using the remote control transmitter 13 according to the instruction of the display screen 10A. When the input information matches the lock release code stored in the memory of the television receiver 100, an image is displayed on the display screen 10A. When the input information does not match the lock release code, there is no image display or audio output. The plurality of inputs 13A include an input to correct the input, an input to reset the television receiver 100 to an initial state, and a confirmation key to confirm a predetermined item.

In the example shown in FIG. 5, the contact information on a third party and the serial number are displayed. For example, the user may lose or smudge the receipt 36 (see FIG. 3) on which the information corresponding to the lock release code (the password) is printed, and thus is unable to read the password. In such a case, by contacting the third party and providing it with the information such as serial number, the user can obtain the information corresponding to the lock release code from the third party.

The third party manages the information corresponding to the lock release code and the information such as serial number in a pair. The third party is allowed to inform the user of the appropriate information corresponding to the lock release code in exchange for the information such as serial number given by the user. In addition, the third party manages the information such as serial number and theft information in a pair, and therefore can keep track of the information such as serial number of the stolen product. As a result, a person who is not an authorized purchaser cannot obtain the information corresponding to the lock release code from the third party even if they make contact with the third party.

In a case where the user is permitted to check the information such as serial number only with the barcode attached to the main body of the television receiver, the barcode indicating the serial number, or attached documents such as a guarantee card, the user may find it difficult to recognize the information such as serial number. By contrast, in the example shown in FIG. 5, the serial number is displayed on the screen, making it easy for the user to recognize the information such as serial number. In the example shown in FIG. 5, the serial number is displayed; alternatively, information other than the serial number, the information with which each product can be distinguished from others may be displayed. Furthermore, in the example shown in FIG. 5, the information such as serial number is displayed at the time of display of the screen in which an input of the information corresponding to the lock release code is requested; however, the information such as serial number may be displayed any other time. For example, the information such as serial number may be displayed when the user performs a special key operation with the remote control transmitter for giving an instruction to display the information such as serial number.

The means for inputting the information is not limited to the example specifically described above, it may be in any form. For example, instead of using the controller, the inputs provided to the television receiver may be used. Also, the display screen to request a user to input the information may be in any form. For example, in a case where there are a plurality of numbers to be input, the display screen shows a few numbers (for example three numbers) for each of the plurality of numbers to be input, and then shows an input screen for the next numbers. Also, numbers may be displayed on the display screen, and a user may select appropriate numbers by touching the screen where the numbers exist. Also, a column to draw a symbol or simple picture may be displayed on the display screen, and the user may draw the information in the column.

The television receiver may request to enter the information at any time. For example, it may be when the power of the television receiver is turned on, or a few seconds after the power is turned on. Also, the input may be confirmed by using a confirmation key after inputting a plurality of numbers as the information. In such case, if the confirmation key is pressed before inputting all the numbers to be input, the display screen does not change and it may display a screen prompting to continue the input.

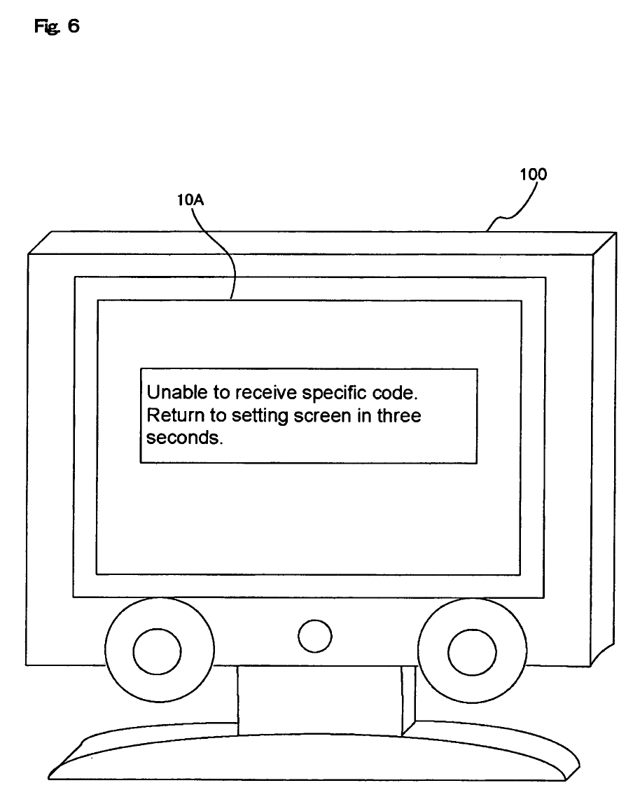

FIG. 6 shows an example of an indication of an error message in step S11. In the example shown in FIG. 6, the display screen 10A of the television receiver 100 displays a message “Unable to receive specific code. Return to setting screen in three seconds”, indicating that, since the user inputs the information which does not match the lock release code, an image is not displayed. The display in which the image display is blocked is not limited to that of FIG. 6, and it may be in any form. For example, an X mark may be displayed on the display screen.

Incidentally, steps S14 to S16 may be removed from the flowchart shown in FIG. 4, such that, once the lock is temporarily released, the temporary release of the lock is maintained until the time when the power of the television receiver is turned off.

In the flowchart shown in FIG. 4, the electronic device is allowed to operate normally for the duration of time that the lock is temporarily released. Alternatively, for the duration of time that the lock is temporarily released, for example, signal reception with a tuner is disabled, and the viewer is only permitted to view the display and listen to the audio produced based on an external input signal.

Moreover, in the flowchart shown in FIG. 4, the first timer starts to measure the time immediately after the power of the television receiver is turned on. Alternatively, step S2 may be removed from the flowchart shown in FIG. 4, and, after a display requesting the input of the information corresponding to the lock release code is displayed on the screen in step S5, the duration of time that no operation is performed with the remote control transmitter may be measured with the first timer.

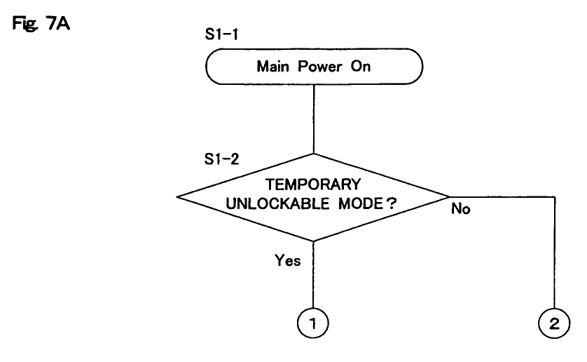

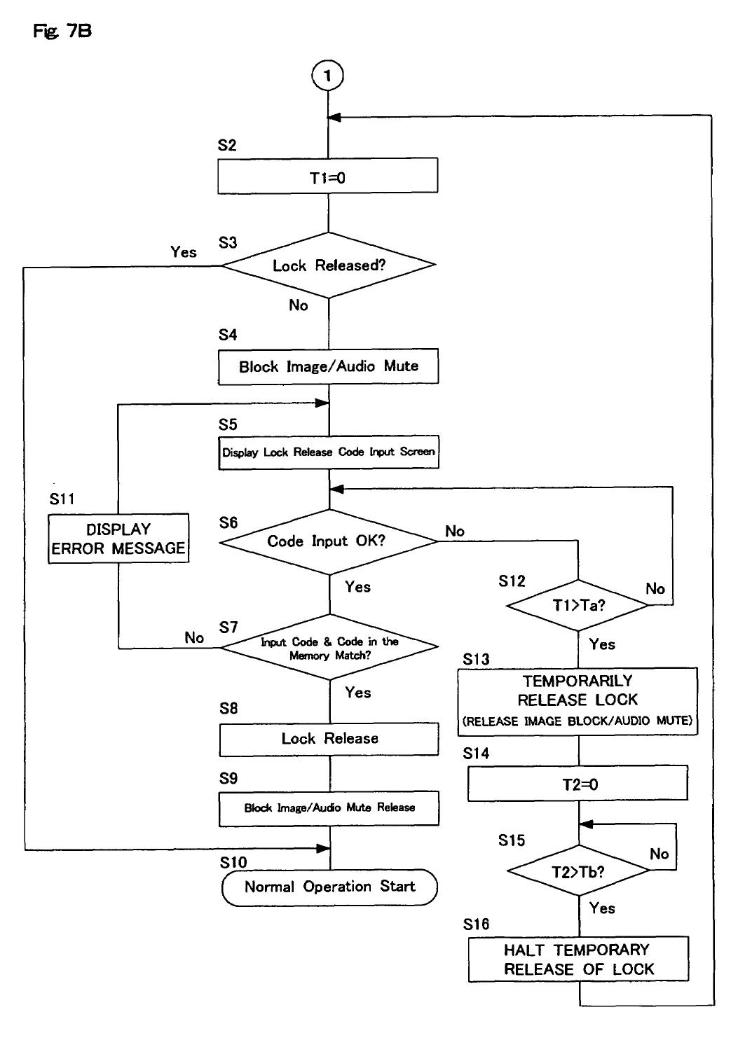

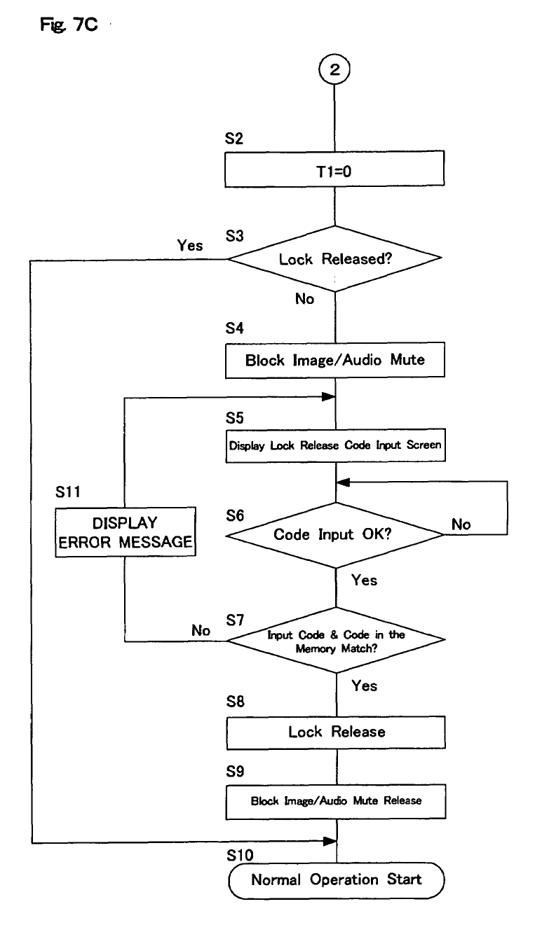

Instead of the above operation described in the flowchart shown in FIG. 4, the television receiver shown in FIG. 1 may perform the operation described in the flowcharts shown in FIGS. 7A to 7C. First, in FIG. 7A, when the power of the television receiver is turned on (step S1-1), the CPU 11 of the television receiver checks whether or not the television receiver is placed in a temporary unlockable mode (step S1-2). For example, the television receiver may be placed in a temporary unlockable mode if the user performs, within a predetermined length of time after the power of the television receiver is turned on, a special key operation with the remote control transmitter for giving an instruction to place the television receiver in a temporary unlockable mode.

If the television receiver is found to be placed in a temporary unlockable mode, the procedure proceeds to the flowchart shown in FIG. 7B. If the television receiver is found not to be placed in a temporary unlockable mode, the procedure proceeds to the flowchart shown in FIG. 7C. In FIGS. 7B and 7C, such processes as are found also in the steps shown in FIG. 4 are identified with common step numbers, and their detailed descriptions will be omitted.

The present invention is not limited to the embodiment above. For example, only a television receiver is explained in FIGS. 1 to 7C; however, the explanations in FIGS. 1 to 7C may be applied to all the electronic devices, such as VCRs, DVD players, camcorders, vacuum cleaners, electric heaters, air conditioners, rice cookers, digital cameras, land-line phones, cellular phones, personal computers, and electric fans. Also, the electronic devices may be provided with a solar cell.

What is claimed is:

1. An electronic device, comprising:
a memory storing a first lock release code;
a comparing portion comparing the first lock release code with a second lock release code that is input with an input device;
a controlling portion releasing a lock if the comparing portion finds that the first lock release code matches the second lock release code, and permitting the electronic device to operate normally; and
a lock release portion releasing the lock, even if the comparing portion finds that the first lock release code does not match the second lock release code, or no code input is made, when a first predetermined time elapses from a predetermined time point.

2. The electronic device of claim 1, wherein
the predetermined time point is determined based on a time point at which power of the electronic device is turned on.

3. The electronic device of claim 1, wherein
the predetermined time point is a start point of a duration of time that no operation is performed with the input device.

4. The electronic device of claim 1, wherein
when the first predetermined time elapses from the predetermined time point, the lock is temporarily released.

5. The electronic device of claim 4, wherein
the lock is temporarily released when the first predetermined time elapses from the predetermined time point, and a temporary release of the lock is maintained until a time when the power of the electronic device is turned off.

6. The electronic device of claim 4, wherein
the lock is temporarily released when the first predetermined time elapses from the predetermined time point, and a temporary release of the lock is maintained until a time when a second predetermined time elapses from a start of the temporary release of the lock.

7. The electronic device of claim 4, wherein
the lock is temporarily released when the first predetermined time elapses from the predetermined time point, and a temporary release of the lock is maintained until a time when the power of the electronic device is turned off before a second predetermined time elapses from a start of the temporary release of the lock, or until a time when the second predetermined time elapses from a start of the temporary release of the lock before the power of the electronic device is turned off.

8. The electronic device of claim 1, wherein
the first predetermined time is sufficiently longer than a time required by a user to release the lock by using the input device.

9. The electronic device of claim 1, wherein
the electronic device is a television receiver.

10. The electronic device of claim 1,
wherein the input device is a remote control transmitter provided separately from the electronic device,
wherein the electronic device comprises a receiving portion for receiving a signal transmitted from the remote control transmitter.

11. A method for preventing theft of an electronic device, comprising the steps of:
storing a lock release code in a memory of the electronic device;
generating information corresponding to the lock release code stored in the memory;
making the electronic device request an input of the information corresponding to the lock release code;
comparing the input information with the lock release code stored in the memory;
releasing a lock if the input information is found to match the lock release code in the comparing step, and permitting the electronic device to operate normally; and
releasing the lock, even if the input information is found not to match the lock release code in the comparing step, or no input of the information is made, when a first predetermined time elapses from a predetermined time point.

12. The method for preventing theft of an electronic device as claimed in claim 11, wherein
the predetermined time point is determined based on a time point at which power of the electronic device is turned on.

13. The method for preventing theft of an electronic device as claimed in claim 11, wherein
the predetermined time point is a start point of a duration of time that no operation is performed with an input device for inputting the information corresponding to the lock release code.

14. The method for preventing theft of an electronic device as claimed in claim 11, wherein
when the first predetermined time elapses from the predetermined time point, the lock is temporarily released.

15. The method for preventing theft of an electronic device as claimed in claim 14, wherein
the lock is temporarily released when the first predetermined time elapses from the predetermined time point, and a temporary release of the lock is maintained until a time when the power of the electronic device is turned off.

16. The method for preventing theft of an electronic device as claimed in claim 14, wherein
the lock is temporarily released when the first predetermined time elapses from the predetermined time point, and a temporary release of the lock is maintained until a time when a second predetermined time elapses from a start of the temporary release of the lock.

17. The method for preventing theft of an electronic device as claimed in claim 14, wherein
the lock is temporarily released when the first predetermined time elapses from the predetermined time point, and a temporary release of the lock is maintained until a time when the power of the electronic device is turned off before a second predetermined time elapses from a start of the temporary release of the lock, or until a time when the second predetermined time elapses from a start of the temporary release of the lock before the power of the electronic device is turned off.

18. The method for preventing theft of an electronic device as claimed in claim 11, wherein
the first predetermined time is sufficiently longer than a time required by a user to release the lock by using an input device for inputting the information corresponding to the lock release code.

19. The method for preventing theft of an electronic device as claimed in claim 11, wherein
the electronic device is a television receiver.

20. The method for preventing theft of an electronic device as claimed in claim 11,
wherein an input device for inputting the information corresponding to the lock release code is a remote control transmitter provided separately from the electronic device,
wherein the electronic device comprises a receiving portion for receiving a signal transmitted from the remote control transmitter.
